(19) United States
(12) Patent Application Publication
(10) Pub. No.: US 2011/0161284 A1
(43) Pub. Date: Jun. 30, 2011

(54) WORKFLOW SYSTEMS AND METHODS FOR FACILITATING RESOLUTION OF DATA INTEGRATION CONFLICTS

(75) Inventors: Tapan Tewari, Framingham, MA (US); Prakash Sridharan, Chennai (IN); Sankar Rajaraman, Chennai (IN); Vazir Ahamed, Chennai (IN)

(73) Assignee: VERIZON PATENT AND LICENSING, INC., Basking Ridge, NJ (US)

(21) Appl. No.: 12/647,864

(22) Filed: Dec. 28, 2009

(51) Int. Cl. G06F 17/30; G06F 9/46

(52) U.S. Cl. 707/609; 707/694; 718/101; 707/E17.005; 707/687; 718/100

(57) ABSTRACT

Exemplary data management, data integration, and workflow systems and methods are disclosed. An exemplary method includes a data integration subsystem maintaining data representative of a set of one or more workflow rules configured for use by a workflow engine within the data integration subsystem to screen one or more data integration conflicts for workflow processing based on the set of one or more workflow rules and generate one or more workflow tasks for the screened one or more data integration conflicts based on the set of one or more workflow rules, receiving user input requesting an update to the set of one or more workflow rules, and dynamically updating, during a runtime of the workflow engine, the data representative of the set of one or more workflow rules to reflect the update. Corresponding systems and methods are also disclosed.

### BACKGROUND INFORMATION

A typical enterprise computing environment includes multiple heterogeneous and distributed database systems supporting a variety of different enterprise organizations and business purposes. For example, many enterprises, such as businesses and the like, maintain different backend database systems to support customer billing, sales, accounting, marketing, inventory, ordering, repairs, service, procurement, etc. Further, many enterprises are the result of a merger of two or more predecessor organizations, each with their own set of heterogeneous and distributed database systems.

There are many reasons why multiple heterogeneous and distributed database systems may exist within an enterprise. Where database systems were created using different technologies or different data models, there may be considerable disruption to the enterprise, not to mention considerable time and expense, in migrating multiple database systems to a common technology platform. In addition, database systems that support different enterprise organizations may be operated in accordance with different business purposes that are not readily reconcilable. Moreover, migration of data may disrupt an enterprise's ability to provide meaningful and consistent information to customers while also maintaining the integrity of the data. For instance, a customer may be granted access to certain account data, but when the account data is migrated from one technology platform to another at the backend, the customer may no longer be able to access the account data as it existed before the migration. Such an occurrence may be inconvenient or even unacceptable to the customer. These and other concerns associated with data migration may delay or prevent an enterprise from migrating data. Thus, although migration of data may be desirable to an enterprise, certain concerns, including difficulties in maintaining data integrity and consistency of data presentation, for example, may prevent an enterprise from migrating data.

Due to the above-described concerns associated with data migration, an enterprise may choose to integrate data maintained by different backend database systems into a set of integrated data that is mapped to and synchronized with the data maintained by the different backend database systems. However, in integrating the data, conflicts across the data maintained by the different backend database systems may be detected. Such conflicts may exist when backend database systems manage data in accordance with different business rules and/or for different business purposes.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical reference numbers designate identical or similar elements.

FIG. 1 illustrates an exemplary data management system.

FIG. 2 illustrates an exemplary data integration and workflow method.

FIG. 3 illustrates exemplary hierarchical data structures.

FIG. 4 illustrates the hierarchical data structures of FIG. 3 updated to reflect a data merge event.

FIG. 5 illustrates an exemplary workflow system.

FIG. 6 illustrates and exemplary workflow rules table.

FIG. 7 illustrates an exemplary workflow rules management method.

### DETAILED DESCRIPTION OF PREFERRED EMBODIMENTS

Exemplary data management, data integration, and workflow systems and methods are disclosed. The exemplary workflow systems and methods may facilitate resolution of data integration conflicts that are detected in a data integration process. As an example, local data may be received from a plurality of local data subsystems (e.g., backend database systems) for integration with a set of global, integrated data maintained by a data integration subsystem. One or more data integration conflicts may be detected in the local data received from the local data subsystems. For example, there may be discrepancies across data provided by one local data subsystem and data provided by another local data subsystem. The detected data integration conflicts may be selectively screened for workflow processing based on a set of one or more workflow rules. One or more workflow tasks may be generated for the screened data integration conflicts and routed to one or more destinations based on the set of workflow rules. For example, the generated workflow tasks may be transmitted to computing devices associated with personnel operating the local data subsystems such that the personnel may be prompted to negotiate, reach agreement, and/or provide information and/or instructions regarding the data integration conflicts. The personnel may provide input in response to the workflow tasks. Resolution of the data integration conflicts may be facilitated based on the responses to the workflow tasks.

The set of workflow rules may be maintained and used by the data integration subsystem to screen the data integration tasks for workflow processing, generate the workflow tasks for the screened data integration conflicts, and route the workflow tasks to appropriate destinations. The workflow rules may represent business rules and/or purposes of business organizations associated with the local data subsystems. The set of workflow rules may be maintained by the data integration subsystem in a manner that enables dynamic updating of the set of workflow rules during a runtime of a workflow engine such that the runtime operation of the workflow engine is not interrupted (e.g., not shutdown or restarted) by the updating of the set of workflow rules. For example, the set of workflow rules may be updated to reflect changes in business rules and/or purposes without having to perform a software code change, build, or release cycle that would require an interruption to operation of the workflow engine. Accordingly, the workflow systems and methods disclosed herein may provide flexibility and convenience in maintaining, updating, and applying workflow rules in a non-intrusive manner for use by the data integration subsystem to facilitate resolution of data integration conflicts in accordance with business rules and/or purposes associated with different business organizations within an enterprise. Hence, the workflow systems and methods described herein may be adaptive to changing business rules and/or purposes of the enterprise.

Components of exemplary data management, data integration, and workflow systems and methods will now be described in reference to the drawings.

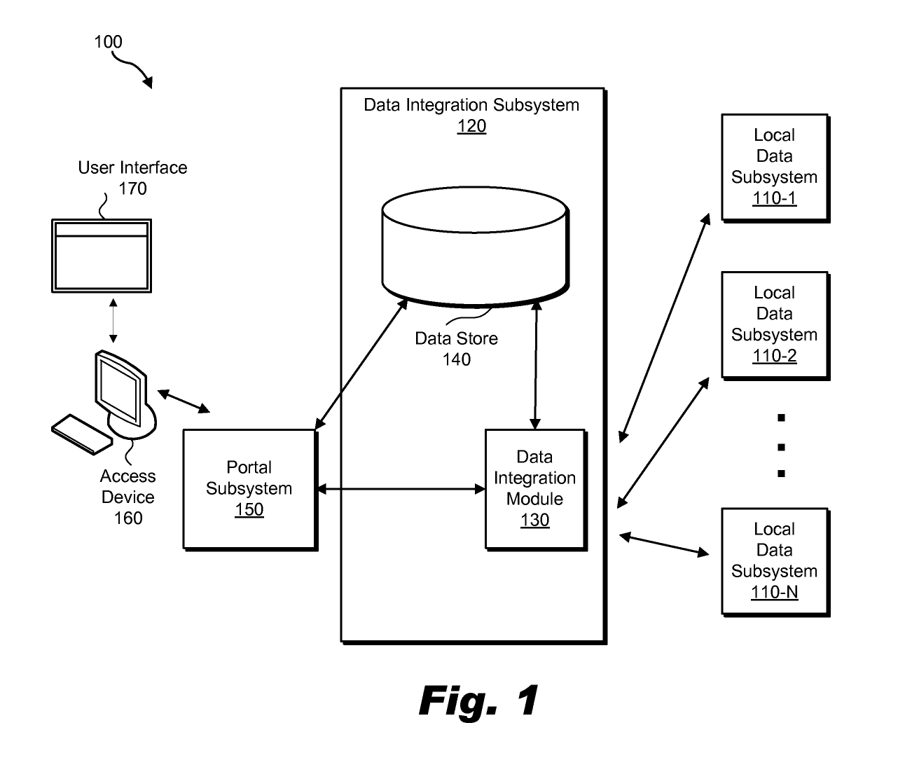

FIG. 1 illustrates an exemplary data management system 100 (or simply “system 100”). As shown in FIG. 1, system 100 may include local data subsystems 110-1 through 110-N (collectively “local data subsystems 110”) communicatively coupled to a data integration subsystem 120 having a data integration module 130 and a data store 140. System 100 may further include a portal subsystem 150 communicatively coupled to data integration subsystem 120 and configured to selectively communicate with an access device 160 that is configured to present a user interface 170 to a user of the access device 160.

Components of system 100 may communicate with one another using any suitable communication technologies, devices, media, and protocols supportive of data communications, including, but not limited to, the Internet, intranets, local area networks, other communications networks, data transmission media, communications devices, Transmission Control Protocol (“TCP”), Internet Protocol (“IP”), File Transfer Protocol (“FTP”), Telnet, Hypertext Transfer Protocol (“HTTP”), socket connections, Ethernet, data bus technologies, and other suitable communications technologies. In certain implementations, at least a subset of communications between local data subsystems 110 and data integration subsystem 120 may be carried out as described in U.S. patent application Ser. No. 11/443,364, entitled “Asynchronous Data Integrity For Enterprise Computing,” filed May 31, 2006 and incorporated herein by reference in its entirety.

In certain implementations, one or more components of system 100 may be implemented in one or more computing devices. System 100 may include any computer hardware and/or instructions (e.g., software programs), or combinations of software and hardware, configured to perform the processes described herein. In particular, it should be understood that components of system 100 may be implemented on one or more physical computing devices. Accordingly, system 100 may include any one of a number of computing devices (e.g., one or more servers), and may employ any of a number of computer operating systems, including, but by no means limited to, known versions and/or varieties of the Microsoft Windows, Unix, and OS/390 operating systems. System 100 may also employ any of a number of database management tools, including, but not limited to, known versions and/or varieties of Microsoft SQL Server and DB2.

Accordingly, one or more of the processes described herein may be implemented at least in part as instructions executable by one or more computing devices. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) may include any medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (“DRAM”), which typically constitutes a main memory. Common forms of computer-readable media may include, for example, a floppy disk, a flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

While an exemplary system 100 is shown in FIG. 1, the exemplary components illustrated in FIG. 1 are not intended to be limiting. Other alternative hardware environments and implementations may be used in other implementations. Exemplary components of system 100 will now be described in additional detail.

Each of the local data subsystems 110 may include one or more computing devices and/or data management applications configured to store and maintain electronic data that may be referred to as “local data.” Each of the local data subsystems 110 may include one or more databases and/or other suitable data storage technologies, including known data storage technologies.

Local data may represent one or more data records and relationships between data records, which may be referred to as local data records and relationships. In certain examples, local data subsystems 110 may be operated by an internal party, and the local data maintained by the internal party may be representative of one or more external parties such as customers of the internal party. As used herein, “internal party” may refer to any person or organization (e.g., a service provider) maintaining data, and “external party” or “external user” may refer to any person or organization that is external to (i.e., not part of) the internal party. Hence, local data may include, but is not limited to, data records representative of customer entities and customer accounts (e.g., service subscribers and subscription accounts), as well as data representing one or more relationships between the customer entities and accounts.

As an example, an external party may include a customer of the internal party, such as a subscriber to services provided by the internal party. The internal party (e.g., a telecommunications enterprise) may maintain data associated with the external party and/or related to the providing of one or more services (e.g., telecommunications services) to the external party. The internal party may maintain local customer-related data in local data subsystems 110.

While certain exemplary implementations described herein refer to customer-related data, which may also be referred to herein as subscriber-related data, the examples are not limiting. Local data may represent other information in other implementations.

The local data subsystems 110 may be associated with different organizations and/or business purposes of the enterprise, including customer billing, sales, accounting, marketing, inventory, ordering, repairs, service, procurement, or other organizations, purposes, or operations of the enterprise. Local data subsystems 110 may also be associated with and/or distributed across different geographic areas.

Typically, local data subsystems 110 are heterogeneous and/or maintain heterogeneous data. For example, one or more of the local data subsystems 110 may store local data according to local data schemas that are different from the local data schemas used by other local data subsystems 110. For instance, local data subsystem 110-1 may employ a first data schema, local data subsystem 110-2 may employ a second data schema, and local data subsystem 110-N may employ another data schema. As used herein, a “data schema” or “data schema type” may refer to a definition of one or more properties, technologies, templates, frameworks, formats, data models, and/or business rules that may be used to represent data. For example, a data schema may provide a framework for naming, storing, and accessing different elements of information. As another example, local data may be maintained in accordance with different business rules across locate data subsystems 110. That is, each of the local data subsystems 110 may be configured to manage its local data in accordance with a particular set of business rules that is specific to an organization within an enterprise.

Data integration subsystem 120 may include any device or combination of devices and communication technologies useful for communicating with portal subsystem 150 and local data subsystems 110. Data integration subsystem 120 may also include any device or combination of devices and data storage and processing technologies useful for storing and processing data, including integrated “global data” that is mapped to local data stored at the local data subsystems 110.

Global data may be mapped from the local data and stored at data integration subsystem 120 in any manner suitable for maintaining data integrity between the global and local data, including preserving behaviors, relationships, and properties of the local data. A mapping between local data and global data may be defined based on local data models, properties of the local data, and/or as may serve a particular implementation. A mapping between local data and global data may also be based on a predefined global data model. Accordingly, a mapping can represent any definition of a set of one or more relationships between local data and global data that can suitably preserve the properties of the local data (or at least certain select properties of the local data) in the global data and that is in accordance with a global data model.

A mapping may be defined in any acceptable manner, including one or more persons (e.g., system administrators or operators) associated with the internal party manually defining a mapping based on the properties and specifications of local data stored in local data subsystems 110 and on a global data model. Alternatively or additionally, automatic mapping operations may be performed to define a mapping based on a predefined mapping heuristic. A defined mapping may be used in subsequent processing for automatically translating between and/or synchronizing the local data and the global data. As described further below, mappings may be used to map global data to local data to fulfill data access requests.

In certain implementations, global data may be mapped to local data in any of the ways described in U.S. patent application Ser. No. 11/443,363, entitled “Systems and Methods for Managing Integrated and Customizable Data,” filed May 31, 2006, and incorporated herein by reference in its entirety. A mapping may be defined based on the exemplary global data model described in the same U.S. patent application Ser. No. 11/443,363.

Data integration subsystem 120 may be configured to maintain global data such that over time the global data accurately represents local data stored in local data subsystems 110. Updates to local data may be carried through to global data in accordance with one of more predefined mappings between the global and local data. The updates may synchronize global data with local data.

Data integration module 130 may be configured to automatically translate data between a global data model implemented in data integration subsystem 120 and one or more of the local data models used by the local data subsystems 110. In particular, data integration module 130 may include one or more agents (e.g., software applications) that are configured to coordinate with local agents associated with the local data subsystems 110 to translate data between the global data model and the local data models. Translation functions may be performed in accordance with one or more of the above-described mappings between local and global data. In certain implementations, data translation operations, including, but not limited to, messaging, prioritization, update, synchronization, and integrity checking operations, may be carried out in any of the ways and using any of the technologies described in the previously mentioned and incorporated U.S. patent application Ser. No. 11/443,364 filed on May 31, 2006. Accordingly, global data stored at data integration subsystem 120 can be updated to reflect changes to the local data and thus accurately represent over time the local data stored at the local data subsystems 110.

Global data may be stored in data store 140, which may include one or more data storage mediums, devices, or configurations and may employ any type, form, and combination of storage media, including, but not limited to, hard disk drives, read-only memory, caches, databases, optical media, and random access memory. Data store 140 may include any suitable technologies useful for storing, updating, modifying, accessing, retrieving, deleting, copying, and otherwise managing data.

Global data may include global data records representing any suitable information, including information associated with one or more external parties, such as information about customer entities and accounts. Data records representative of customer entities and accounts may be referred to as “subscriber records” and “subscription records,” respectively. Such data records may include any information related to customer entities and accounts, including customer and/or account identifiers. The data records may also include type identifiers indicative of various types of data records. For example, a type identifier may indicate whether a data record is a subscriber or subscription record.

Global data may also include map records representative of links between data records. Accordingly, map records may be used to define one or more data relationships between data records such as subscriber and subscription records. Map records may include map record identifiers, as well as identifiers for data records linked by the map records. Map records may also include relationship type identifiers indicative of relationship types between data records. For example, map record type identifiers may indicate whether map records are associated with a fixed or customizable data relationship (i.e., unchangeable or changeable by an external party), or the types of data records that are linked by the map records (e.g., subscriber-to-subscriber, subscriber-to-subscription, or subscription-to-subscription map records). Global data, including global data and map records, may be assigned unique identifiers that enable the global data records to be used across system 100.

Global data and map records may be grouped to represent sets of data relationships. For example, data records may be linked by one or more map records to form a “data structure” representing a set of data relationships. Typically, such a data structure may define a hierarchical data tree having data records as nodes and map records linking the data records together to define a set of relationships between the data records. Any suitable data entity may be used to define a data structure, including one or more relational or hierarchical data tables, for example.

While global and local data may be used for the operations of an internal party operating the data integration subsystem 120 and local data subsystems 110, access to at least a subset of the global data may be selectively provided for external user access (i.e., for access by one or more users associated with an external party). External user access to local data may be gained by way of the global data. This may allow an external party to access, manage, and utilize global data, and consequently local data, maintained by the internal party.

Portal subsystem 150 may be configured to provide external access to global data stored at data store 140, as well as to local data by mapping global data to local data. Portal subsystem 150 may include or be implemented on one or more computing devices. Portal subsystem 150 and data integration subsystem 120 may be implemented on one computing device or on a plurality of computing devices. In certain implementations, portal subsystem 150 includes or is implemented by one or more servers (e.g., web servers) configured to selectively communicate with access device 160. Portal subsystem 150 and access device 160 may communicate over a communication network, which may include any network suitable for carrying communications between access device 160 and portal subsystem 150, including, but not limited to, the Internet or an intranet. In certain implementations, portal subsystem 150 provides an access portal by which external users can access and utilize global data stored in data store 140.

An external user may utilize access device 160 to communicate with portal subsystem 150 and access and manage global data. Access device 160 may include any device physically or remotely accessible to one or more users and that allows a user to provide input to and receive output from portal subsystem 150. For example, access device 160 may include, but is not limited to, one or more desktop computers, laptop computers, tablet computers, personal computers, personal data assistants, cellular telephones, satellite pagers, wireless internet devices, embedded computers, video phones, mainframe computers, mini-computers, programmable logic devices, vehicular computers, Internet-enabled devices, and any other devices capable of communicating with portal subsystem 150. Access device 160 can also include or interact with various peripherals such as a terminal, keyboard, mouse, screen, printer, stylus, input device, output device, or any other apparatus that can help a user interact with access device 160.

Access device 160 may provide external access to portal subsystem 150 and consequently to data integration subsystem 120 via the portal subsystem 150. Accordingly, one or more users associated with an external party may utilize access device 160 to provide requests to and receive output from portal subsystem 150.

Access device 160 may include instructions for generating and operating user interface 170. The instructions may be in any computer-readable format, including software, firmware, microcode, and the like. When executed by a processor (not shown) of access device 160, the instructions may present user interface 170 to a user of access device 160. User interface 170 may be configured to present representations of global data, local data, and one or more data management tools configured to enable a user to externally access and use the global and/or local data.

User interface 170 may comprise one or more graphical user interfaces (“GUIs”) configured to display information and receive input from users. In certain exemplary implementations, user interface 170 includes a web browser, such as Internet Explorer, Mozilla Firefox, Safari, and the like. However, user interface 170 is not limited to web-based and/or graphical implementations and may include many different types of user interfaces that enable users to utilize access device 160 to communicate with portal subsystem 150. In some implementations, for example, user interface 170 may include a voice interface capable of receiving voice input from and/or providing voice output to a user.

A single access device 160 is shown in FIG. 1 for illustrative purposes only. It will be recognized that one or more access devices 160 may communicate with portal subsystem 150 and gain external access to global data.

External access to global data and/or local data may be based on permissions settings maintained by portal subsystem 150. Permissions settings may be stored in portal subsystem 150, data store 140, or at an external location. Portal subsystem 150 may access and use permission settings to determine whether users have permission to access certain global and/or local data, or to determine the specific global and/or local data accessible to users. This allows portal subsystem 150 to selectively provide users or groups of users with access to different sets of global and/or local data in accordance with the permissions settings. Permissions settings may be included in one or more user profiles maintained by portal subsystem 150 and/or data integration subsystem 120. The user profiles may correspond with users associated with an external party. Portal subsystem 150 may be configured to maintain user permissions settings in any of the ways described in U.S. patent application Ser. No. 11/584,098, entitled “Integrated Data Access” and filed Oct. 20, 2006, U.S. patent application Ser. No. 11/584,111, entitled “Integrated Application Access” and filed Oct. 20, 2006, and/or the previously mentioned U.S. patent application Ser. No. 11/443,363 filed on May 31, 2006, each of which is herein incorporated by reference in its entirety.

As mentioned, global data maintained by data integration subsystem 120 through performance of one or more data integration processes may be mapped to and accurately represent local data over time. To this end, when local data is updated within local data subsystems 110, the updates may be propagated to the global data. For example, local data subsystems 110 may generate and provide data representative of local data updates to data integration subsystem 120, which may receive and integrate the updates into global data in data store 140 in any of the ways described above.

In association with the integration of local data updates into global data maintained in data store 140, data integration subsystem 120 may be configured to detect conflicts in data across local data subsystems 110 and to selectively perform workflow processing to facilitate resolution of the conflicts. In certain examples, the workflow processing may seek user input (e.g., from one or more personnel associated with the internal party) to determine how to resolve the conflicts.

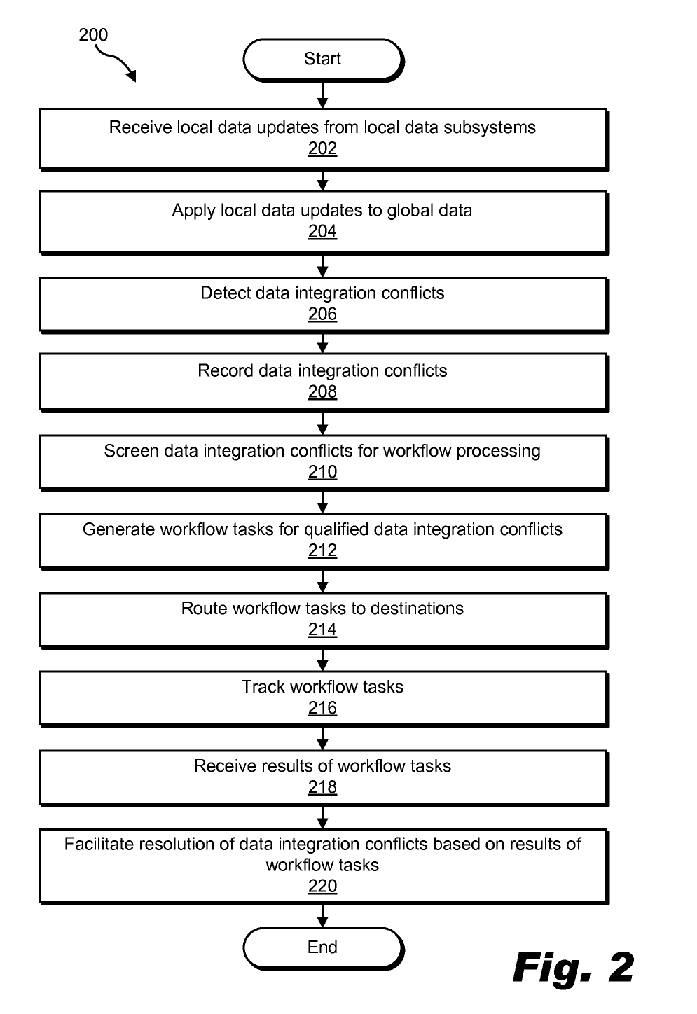

To illustrate, FIG. 2 shows an exemplary data integration and workflow method 200. While FIG. 2 illustrates exemplary steps according to one embodiment, other embodiments may omit, add to, reorder, and/or modify any of the steps shown in FIG. 2. In certain embodiments, one or more of the steps shown in FIG. 2 may be performed by one or more components of data integration subsystem 120 such as data integration module 130.

In step 202, local data updates are received from local data subsystems 110. For example, data integration subsystem 120 may receive data representative of local data updates from local data subsystems 110. The local data updates may represent the local data maintained by local data subsystems 110, including any updates that have been made to the local data maintained by local data subsystems 110 since the data integration subsystem 120 last synchronized the global data with the local data. In certain examples, the local updates may represent updates to local data triggered by one or more business activities such as customer mergers, divestitures, superseding, buy outs, acquisitions, moves, and/or changes.

In step 204, the local data updates are applied to global data. For example, data integration subsystem 120 may apply the local data updates to global data maintained in data store 140. The application of the local data updates to the global data may be designed to synchronize the global data with the local data maintained by local data subsystems 110 in any of the ways described above and/or in the previously mentioned and incorporated U.S. patent application Ser. No. 11/443,364 filed on May 31, 2006.

In step 206, data integration conflicts are detected. For example, in association with the application of the local data updates to the global data in step 204, data integration subsystem 120 may detect one or more conflicts across the local data maintained by local data subsystems 110. For example, in the updates, local data maintained by local data subsystem 110-1 may conflict with local data maintained by local data subsystem 110-2. An example of a data integration conflict is described in more detail further below. A data integration conflict may include any discrepancy between local data received from one local data subsystem 110 and local data received from another local data subsystem 110. In certain embodiments, data integration conflicts may include various types of discrepancies, including, but not limited to, discrepancies within data records (i.e., “content discrepancies”) and discrepancies between hierarchical organizations of data records (“mapping discrepancies”).

Data integration conflicts may be detected in any suitable way in step 206. For example, data integration subsystem 120 may be configured to perform one or more operations to compare local data updates across local data subsystems 110. For example, data integration subsystem 120 may compare local data received from local data subsystem 110-1 to local data received from local data subsystem 110-2 to identify any discrepancies. In certain embodiments, data integration subsystem 120 may execute one or more predefined procedures (e.g., Structured Query Language (“SQL”) procedures) on global data and/or received local data to perform the comparison.

In step 208, the detected data integration conflicts are recorded. For example, data integration subsystem 120 may record data representative of the data integration conflicts detected in step 206 into a discrepancies data table. The recorded data may be utilized for subsequent workflow processing.

In step 210, the data integration conflicts are screened for workflow processing. For example, data integration subsystem 120 may screen the recorded data integration conflicts to determine whether the data integration conflicts qualify for workflow processing. One or more predefined conditions may be used to determine whether data integration conflicts qualify for workflow processing. In certain embodiments, the screening may be based on a set of workflow rules, which may specify one or more conditions to be satisfied to qualify data integration conflicts for workflow processing. Examples of workflow rules and screening conditions are described in more detail further below.

In step 212, workflow tasks for qualified (i.e., “screened”) data integration conflicts are generated. For example, data integration subsystem 120 may generate one or more workflow tasks for the data integration conflicts that have been determined to qualify for workflow flow processing. In certain embodiments, the workflow tasks may be generated based on a set of workflow rules, examples of which are described in more detail further below. A workflow task may include a data object representative of one or more workflow processes to be performed to facilitate resolution of a data integration conflict. For example, a workflow task may prompt a recipient of the workflow task to review and either accept or reject one or more data updates.

In certain examples, a workflow task may include information about a data update and/or contextual information about a data update that may be helpful to a recipient of the task request. Examples of such information may include, without limitation, information indicating users who have access to customer and/or account data, users who would lose or gain access to customer and/or account data if a data update is approved, permission groups that grant access to customer and/or account data directly or indirectly, impacts of a data update, current values of customer and/or account data, proposed changes to customer and/or account data, and customer and/or account data hierarchies associated with a data update.

In step 214, the workflow tasks are routed to one or more destinations. For example, data integration subsystem 120 may route the workflow tasks to one or more destinations. In certain embodiments, the destinations may include one or more computing devices associated with operators of local data subsystems 110 and/or personnel (e.g., managers) of enterprise business organizations associated with local data subsystems 110. Data integration subsystem 120 may determine the destinations to which the workflow tasks are to be routed based on one or more predefined workflow rules, examples of which are described further below.

In step 216, the workflow tasks are tracked. For example, data integration subsystem 120 may track the routing and statuses of the workflow tasks, as well as responses received from the destinations to which the workflow tasks have been routed.

In step 218, responses to the workflow tasks are received. For example, data integration subsystem 120 may receive responses from the destinations to which workflow tasks were routed in step 214. Examples of such responses may include, but are not limited to, approvals and/or rejections of data updates, proposed resolutions to data integration conflicts, approvals and/or rejections of proposed resolutions to data integration conflicts, deferrals of workflow tasks, and holds placed on workflow tasks. A response received from a destination to which a workflow task has been routed may include instructions to be performed by data integration subsystem 120 to facilitate resolution of a conflict.

In step 220, resolution of the data integration conflicts is facilitated based on the responses received in step 218. For example, data integration subsystem 120 may perform one or more operations to facilitate resolution of the data integration conflicts based on the responses to the workflow tasks. As an example, the results received in step 218 may include an approval of a data update. In response to the approval, data integration subsystem 120 may initiate performance of operations configured to propagate the data update throughout global data. For instance, data integration subsystem 120 may propagate a data update from one hierarchical data structure (e.g., a marketing hierarchical data structure for a customer) to another hierarchical data structure (e.g., a service hierarchical data structure for the customer) in the global data to resolve the conflict across the data structures in the global data. As another example, if a rejection of a data update is received, data integration subsystem 120 may omit and/or reverse (i.e., “roll back”) the data update in the global data. In certain embodiments, previous data values and/or procedures may be maintained and used to reverse data updates such as when a data update is rejected in a workflow process. In addition, data integration subsystem 120 may provide notification messages to one or more of the local data subsystems 110 responsible for the data update to provide notification of the approval or the rejection of the update. This may give personnel operating the local data subsystems 110 opportunity to determine how to handle a conflicting data update. Notifications may be provided in any suitable by such as by posting messages to a user interface or portal and/or transmitting e-mail messages.

One or more steps shown in FIG. 2 may be repeated for other sets of local data updates received by data integration subsystem 120. For instance, the above-described example may refer to a first set of local data updates. Subsequently, a second set of one or more local data updates may be received from local data subsystems 110, and a second set of one or more data integration conflicts may be detected based on the second set of local data updates. Workflow processing may be performed as described above to screen the second set of data integration conflicts, generate one or more other workflow tasks for the screened data integration conflicts, and route the one or more other workflow tasks to one or more destinations to facilitate resolution of the second set of data integration conflicts.

In certain examples, a resolution of a data integration conflict may be used by data integration subsystem 120 to determine which data to make available to portal subsystem 150 for access and viewing by an external party. For example, where the data view to which an external party is given access via portal subsystem 150 is a service or billing data view, an update made initially to a marketing data view may not be made available for external access until approval of the update is received via a workflow process and the update is propagated to a service or billing data view.

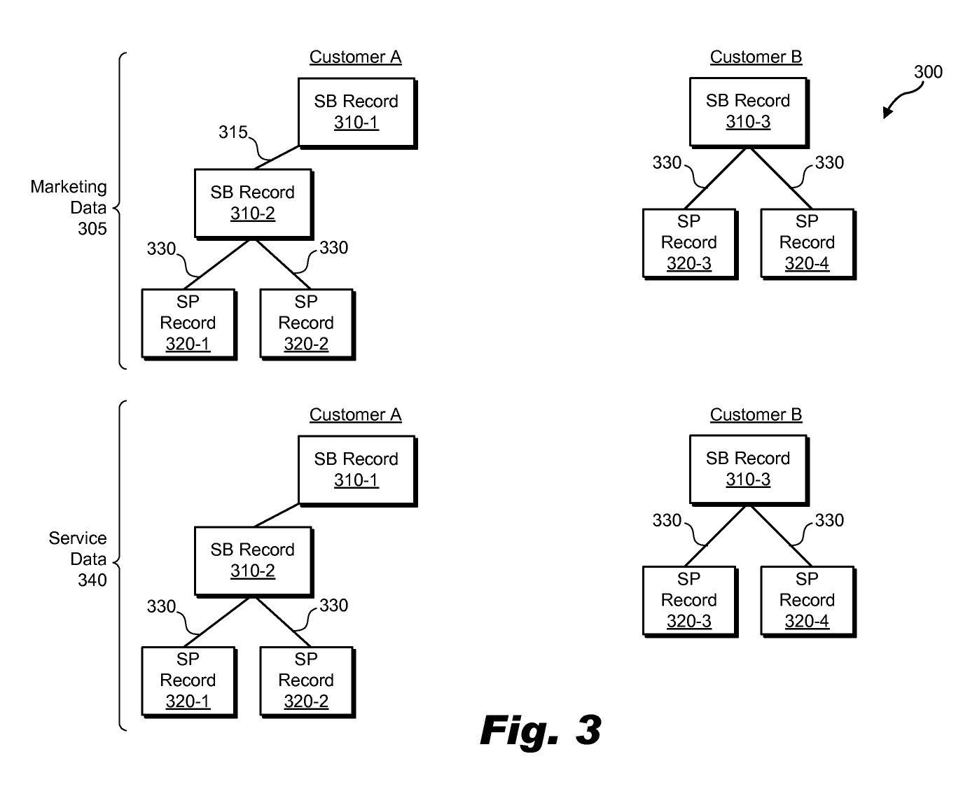

To further facilitate an understanding of method 200, a specific example of workflow-based processing of a data integration conflict will now be described. FIG. 3 illustrates a view 300 of exemplary hierarchical data structures. As shown, marketing data 305 may include hierarchical data structures for two customers—“Customer A” and “Customer B.” Marketing data 305 may be associated with local data subsystem 110-1, which may be operated by a marketing organization of an enterprise. For example, marketing data 305 may represent local data maintained by local data subsystem 110-1 and/or global data maintained by data integration subsystem 120 and that is mapped to local data maintained by local data subsystem 110-1.

As shown in FIG. 3, the hierarchical data structure associated with Customer A in marketing data 305 may include a subscriber record 310-1 representing Customer A and positioned as the root node of the hierarchical data structure. A subscriber record 310-2, which may represent a subsidiary or branch of Customer A, may be positioned as a child node of subscriber record 310-1. Subscriber record 310-2 may be mapped to subscriber record 310-1 by a subscriber-to-subscriber mapping record 315. Subscription records 320-1 and 320-2 may be positioned as child nodes of subscriber record 310-2 and mapped to subscriber record 310-2 by subscriber-to-subscription mapping records 330. Subscription records 320-1 and 320-2 may represent customer accounts of Customer A.

In marketing data 305, the hierarchical data structure associated with Customer B may include a subscriber record 310-3 representing Customer B and positioned as the root node of the hierarchical data structure. Subscription records 320-3 and 320-4 may be positioned as child nodes of subscriber record 310-3 and mapped to subscriber record 310-3 by subscriber-to-subscription mapping records 330. Subscription records 320-3 and 320-4 may represent customer accounts of Customer B.

As further shown in FIG. 3, service data 340, which is separate of marketing data 305, may also include hierarchical data structures for Customer A and Customer B. Service data 340 may be associated with another local data subsystem 110-2, which may be operated by a service organization of the enterprise. For example, service data 340 may represent local data maintained by local data subsystem 110-2 and/or global data maintained by data integration subsystem 120 and that is mapped to local data maintained by local data subsystem 110-2.

As shown in FIG. 3, the hierarchical data structures in service data 340 are identical to the hierarchical data structures in marketing data 305. Consequently, there are not any discrepancies between marketing data 305 and service data 340 for Customer A and Customer B.

A business activity such as a merger of Customer A and Customer B may occur. For example, Customer A may acquire Customer B. In response to the merger, marketing data 305 may be updated to reflect the merger. However, for any of a number of possible business reasons, service data 340 may not yet be updated to reflect the merger. For example, a marketing organization may update local data in local data subsystem 110-1 to reflect the merger in response to an announcement or an effective date of the merger while a service organization may wait until finalization or some other event associated with the merger to update local data subsystem 110-2 to reflect the merger.

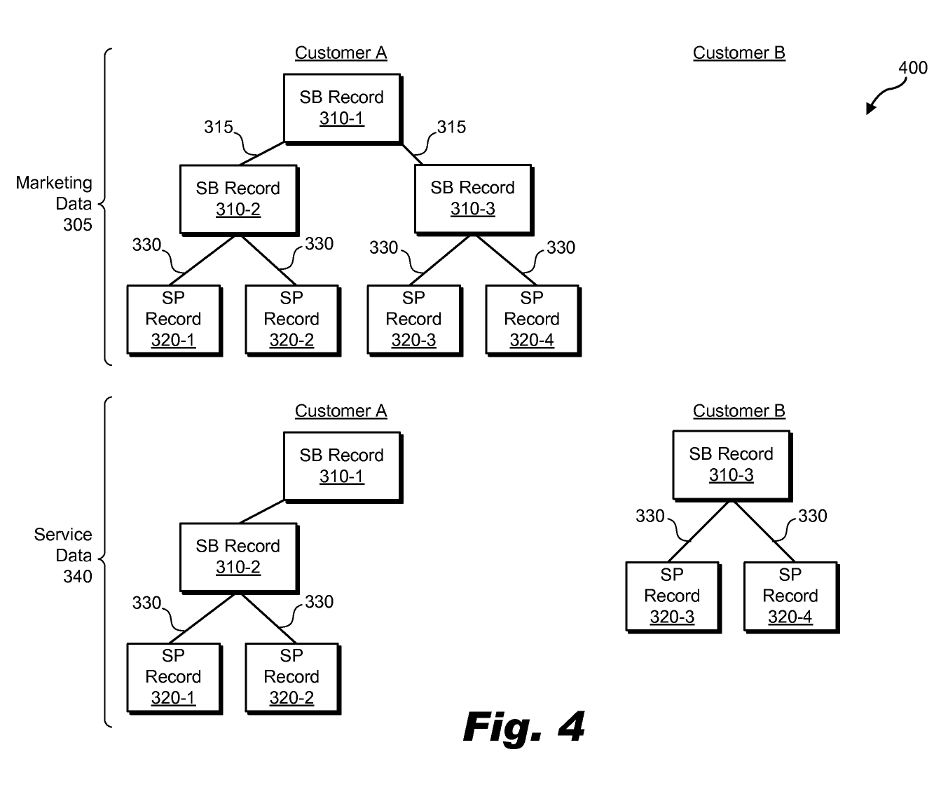

FIG. 4 illustrates a view 400 of exemplary hierarchical data structures as they may exist after a merger of Customer A and Customer B has occurred. As shown, marketing data 305 may be updated by moving the hierarchical data structure associated with Customer B within the hierarchical data structure associated with Customer A to reflect the acquisition of Customer B by Customer A. In FIG. 3, subscriber node 310-3, which may now represent a subsidiary or branch of Customer A, may be positioned as a child node of subscriber record 310-1. Subscriber record 310-3 may be mapped to subscriber record 310-1 by a subscriber-to-subscriber mapping record 315. Subscription records 320-3 and 320-4 remain child nodes of subscriber record 310-3. Because Customer B is subsumed within Customer A, there is no longer a root node representing Customer B in marketing data 305.

In FIG. 4, service data 340 remains unchanged from FIG. 3. In other words, service data 340 has not been updated to reflect the acquisition of Customer B by Customer A.

Because the hierarchical data structures for Customer A and Customer B are now different across marketing data 305 and service data 340, data integration subsystem 120 may detect discrepancies. For example, data integration subsystem 120 may receive local data updates from local data subsystems 110-1 and 110-2. The local data updates may represent the hierarchical data structures shown in FIG. 4. Data integration subsystem 120 may apply the local data updates to global data. For example, data integration subsystem 120 may propagate the local data updates received from local data subsystem 110-1 into a global marketing data structure maintained by data integration subsystem 120. Data integration subsystem 120 may also propagate the local data updates received from local data subsystem 110-2 into a global service data structure maintained by data integration subsystem 120. Data integration subsystem 120 may subsequently execute a synchronization (e.g., a periodic inheritance) process configured to synchronize the data views within the global data. In association with this process, data integration subsystem 120 may detect discrepancies between the hierarchical data structures for Customer A and Customer B across marketing data 305 and service data 340. The discrepancies, which may be referred to as data integration conflicts, may be recorded by data integration subsystem 120. For example, data descriptive of or otherwise representative of the discrepancies may be recorded in a discrepancies table.

The discrepancies table may include any information associated with one or more detected discrepancies. For example, the discrepancies table may include, without limitation, information such as discrepancy identifiers, discrepancy type identifiers, references to affected hierarchical data structures and/or positions within hierarchical data structures, descriptions of updates, identifiers of users responsible for updates, identifiers of customers and/or accounts associated with updates, and timestamps associated with updates.

Data integration subsystem 120 may screen the recorded discrepancies for workflow processing. The screening may be based on a set of workflow rules. For example, data integration subsystem 120 may identify, from the recorded discrepancies, any discrepancies that match workflow processing conditions specified in the workflow rules. The matching discrepancies may be selected (i.e., screened) and subjected to workflow processing to facilitate resolution of the discrepancies.

In certain embodiments, for each workflow rule in the set of workflow rules, the discrepancies recorded in a discrepancies table may be screened to identify any of the discrepancies that match the conditions specified by the workflow rule. For instance, a particular workflow rule may specify that any discrepancies that include a change in mappings within the hierarchical data structures for Customer A or Customer B qualifies for workflow processing based on the workflow rule. Accordingly, the discrepancies illustrated in FIG. 4 may qualify and may be screened for workflow processing based on the workflow rule.

Data integration subsystem 120 may generate workflow tasks for the screened discrepancies. The workflow tasks may be generated based on information included in a workflow rule to which the screened discrepancies have been matched. Data integration subsystem 120 may then route the workflow tasks to one or more destinations. The workflow tasks may be routed based on information included in a workflow rule to which the screened discrepancies have been matched. In certain embodiments, for example, the workflow tasks may be transmitted to computing devices associated with personnel of local data subsystems 110-1 and 110-2. The workflow tasks may be designed to solicit input from the personnel. The personnel may provide input to the workflow tasks, and the computing devices associated with the personnel may transmit the responses to the workflow tasks to data integration subsystem 120.

Data integration subsystem 120 may receive and process the responses to the workflow tasks to facilitate resolution of the discrepancies. For example, a response may indicate a collaborative approval of the update made in marketing data 305. Data integration subsystem 120 may respond by propagating the update from marketing data 305 to service data 340 and thereby resolve the discrepancies. As another example, a response may include a rejection of the update made in the marketing data 305. The rejection may be provided by service personnel operating local data subsystem 110-2. Data integration subsystem 120 may respond to the rejection by notifying marketing personnel associated with local data subsystem 110-1 of the rejection to give the marketing personnel an opportunity to resolve the discrepancies (e.g., by reversing the update locally) or to propose a solution to the service personnel.

As mentioned, one or more workflow processes, such as the screening, generating, and routing processes described above, may be performed in accordance with a set of workflow rules. The workflow rules may be defined by one or more persons associated with the internal party operating data integration subsystem 120 to suit one or more business rules and/or purposes of an enterprise and/or organizations within the enterprise. Inasmuch as business rules, purposes, and activities tend to change, one or more persons associated with the internal party may want to update the set of workflow rules. To this end, convenient, flexible, and non-intrusive configurations and tools for managing the set of workflow rules may be provided. Accordingly, a person associated with the internal party may request that an update may made to the set of workflow rules, and in response data representative of the workflow rules may be conveniently, flexibly, and non-intrusively updated by data integration subsystem 120 to reflect the requested update.

In certain embodiments, the workflow rules may be dynamically and seamlessly updated on-the-fly during runtime of a workflow engine, data integration subsystem 120, and/or portal subsystem 150, without interrupting (e.g., without shutting down or restarting) the runtime operation of the workflow engine, data integration subsystem 120, and/or portal subsystem 150. Accordingly, an update to the workflow rules may be implemented without having to perform a conventional software build to change workflow engine code. Such a software build typically requires a significant amount of time and coordination, as well as an interruption to runtime operations.

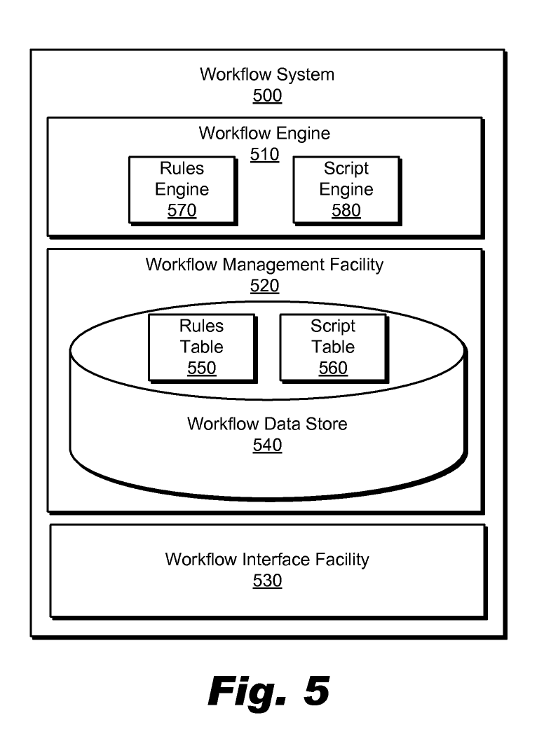

FIG. 5 illustrates an exemplary workflow system 500 (or simply “system 500”), which may be implemented in data integration subsystem 120. For example, system 500 may be implemented in data integration module 130 or as a separate module in data integration subsystem 120. System 500 may be implemented by one or more computing devices and may be configured to perform one or more of the workflow processes described herein.

As shown in FIG. 5, system 500 may include a workflow engine 510, a workflow management facility 520, and the workflow interface facility 530, which may be communicatively coupled to one another using any suitable technologies. Workflow engine 510 may be configured to perform one or more of the workflow processes described herein. For example, workflow engine 510 may be configured to screen data integration conflicts for workflow processing, generate workflow tasks for selected data integration conflicts, and route the workflow tasks to one or more destinations.

Workflow engine 510 may be configured to perform one or more of the workflow processes described herein in accordance with a set of workflow rules, which may be maintained by workflow management facility 520. The set of workflow rules may be stored in a workflow rules table. For example, as shown in FIG. 5, workflow management facility 520 may include a workflow data store 540 storing a rules table 550 and a script table 560. Workflow data store 540 may be implemented by any suitable data storage technologies. Rules table 550 may include a set of one or more workflow rules configured to be used by workflow engine 510 and performing one or more of the workflow process described herein. Script table 560 may include one or more executable scripts configured to be executed by workflow engine 510 in the performing of one or more of the workflow processes described herein. In certain embodiments, rules table 550 may include data mapping rules within rules table 550 to scripts within script table 560. For example, a particular workflow rule in rules table 550 may include information mapping the workflow rule to one or more scripts included in script table 560. The workflow rule may direct workflow engine 510 to the one or more scripts in script table 560 that are to be executed in association with the workflow rule. In certain embodiments, the scripts may include JET scripts configured to be executed by a JET script engine.

As shown in FIG. 5, workflow engine 510 may include a rules engine 570, which may be configured to process rules table 550. Workflow engine 510 may also include a script engine 580 configured to process script table 560, including executing one or more scripts included in script table as directed by rules engine 570 and/or rules table 550.

An exemplary workflow process will now be described in the reference to workflow system 500. As mentioned, one or more data integration conflicts may be identified and recorded in a discrepancies table. Workflow engine 510 may be configured to perform a screening process to screen the data integration conflicts for workflow processing. For example, the workflow engine 510 may utilize a set of workflow rules included in rules table 550 to screen the data integration conflicts included in the discrepancies table to identify, select, and retrieve one or more of the data integration conflicts that qualify for workflow processing based on the set of workflow rules in rules table 550. For instance, for each rule included in the set of workflow rules, workflow engine 510 may query the discrepancies table and identify any of the data integration conflicts within the discrepancies table that match one or more conditions specified by the rule. To this end, each workflow rule within the set of workflow rules may specify one or more conditions for a data integration conflict to qualify for workflow processing based on the workflow rule. Accordingly, data integration conflicts included in the discrepancies table may be appropriately matched to particular workflow rules within rules table 550 and retrieved from discrepancies table for further workflow processing in accordance with the matching workflow rules.

In certain embodiments, workflow engine 510 may be configured to perform a workflow process periodically (e.g., nightly) or in response to a predetermined event. The workflow process may comprise a predefined stored procedure that processes rules table 550 by iteratively considering each enabled workflow rule in rules table 550 to identify any discrepancies included in the discrepancies table that qualify for workflow processing in accordance with the workflow rule. The workflow rule may include information specifying one or more conditions to be satisfied in order for a discrepancy to qualify for workflow processing in accordance with the workflow rule. Examples of such information may include, without limitation, information specifying one or more particular customers, accounts, hierarchical data structures, types of discrepancies, and types of updates (e.g., mapping and/or content changes) that qualify for workflow processing under the workflow rule. To illustrate, a workflow rule may specify that discrepancies related to updates that change mapping relationships within a hierarchical data structure associated with a particular customer (e.g., Customer A) qualify for workflow processing under the rule. In certain embodiments, a workflow rule may specify one or more scripts in script table 500 to be executed, as part of the screening of the discrepancies, to apply the screening conditions for the workflow rule to determine whether the discrepancies qualify for workflow processing in accordance with the workflow rule. Script engine 580 may execute the scripts to apply the screening conditions and provide output indicating whether workflow tasks are to be generated for discrepancies using one or more attributes of the discrepancies and/or corresponding data updates.

For each data integration conflict that is determined to match the screening conditions for a particular workflow rule, workflow engine 510 may generate one or more workflow tasks based on information included in the workflow rule. For instance, workflow engine 510, as part of the workflow process performed periodically (e.g., nightly) or in response to a predetermined event, may generate one or more workflow tasks for a screened discrepancy based on one or more attributes of the discrepancy and/or corresponding data update received from the script engine 580.

Workflow engine 510 may be further configured to route the generated workflow tasks to appropriate destinations based on information specified in the workflow rule. For example, the workflow rule may specify information for one or more computing devices associated with particular personnel to whom the workflow tasks should be routed.

In the above-described or similar manner, workflow engine 510 may be configured to perform one or more of the workflow processes described herein in accordance with a set of workflow rules included in rules table 550.

Workflow system 500 may be configured for convenient, flexible, and/or non-intrusive management of the set of workflow rules included in rules table 550 and configured to be used to dictate workflow processing behavior. For example, the set of workflow rules in rules table 550 may be conveniently and non-intrusively updated during run time of workflow engine 510 without requiring an interruption to the operation of workflow engine 510. Such an update may be made without having to perform a software build to update the code of workflow engine 510.

To illustrate, workflow interface facility 530 may be configured to provide a user interface through which a user associated with the internal party operating data integration subsystem 120 may provide user input requesting one or more updates to the set of workflow rules and rules table 550. The user interface may include a graphical user interface and/or any other user interface suitable for use by an internal party user to request an update to rules table 550. In certain embodiments, workflow interface facility 530 may be configured to provide the user interface and/or one or more tools for managing workflow rules for access through portal subsystem 150.

Workflow interface facility 530 may receive the user input requesting the update to the set of rules included in rules table 550. Workflow interface facility 530 may communicate data representative of the update request to workflow management facility 520. Workflow management facility 520 may receive the data representative of the update request from workflow interface facility 530 and respond by dynamically updating, during a runtime of workflow engine 510, the set of workflow rules to reflect the update in rules table 550.

In certain examples, the update request may include information for updating script table 560 in conjunction with the updating of rules table 550. For example, the update request may include one or more scripts associated with the update to the set of workflow rules. Workflow management facility 520 may update the scripts in script table 560 to reflect the update. The updating of scripts in script table 560 may also be performed dynamically during a run time of workflow engine 510.

Several examples of updates to the set of workflow rules included in rules table 550 will now be described. In certain examples, an update request may include a request to add a new workflow rule to the set of workflow rules in rules table 550. The request may include information to be included in and/or otherwise associated with the rule. For example, the request may include one or more scripts to be associated with the new workflow rule. Workflow management facility 520 may receive the request and respond by adding data representative of the new workflow rule to rules table 550. In addition, workflow management facility 520 may add one or more scripts corresponding to the new rule to script table 560. As an example, a user associated with the internal party operating data integration subsystem 120 may learn of a merger of Customer A and Customer B and may wish to add a new workflow rule to rules table 550 that is designed to handle workflow processing for data integration conflicts associated with the merger of Customer A and Customer B. The new workflow rule may include information specifying one or more conditions to be satisfied in order for a data integration conflict to qualify for workflow processing in accordance with the new workflow rule, information identifying one or more scripts to be executed to generate one or more workflow tasks for qualified data integration conflicts, and information specifying one or more destinations to which the workflow tasks will be routed.

As another example, an update request may include a request to modify a workflow rule that already exists in rules table 550. For example, a user associated with the internal party operating data integration subsystem 120 may utilize an interface provided by workflow interface facility 530 to provide user input requesting an update to the existing workflow rule. Workflow management facility 520 may receive the request and dynamically update the workflow rule in rules table 550 to reflect the update. As an example, a manager of a business organization within an enterprise may change. For instance, the current manager may be promoted to another position within the business organization, and a new manager may be appointed. In view of this change, it may be desirable to update one or more workflow rules in rules table 550 to change workflow task routing information such that workflow tasks may be routed to the new manager instead of the previous manager.

As another example, an update request may include a request to enable or disable a workflow rule included in rules table 550. To support this feature, each of the workflow rules in rules table 550 may include a data field specifying whether the workflow rule is enabled or disabled. When a workflow rule is marked as disabled, workflow engine 510 may skip over the disabled workflow rule when performing workflow processing. When a workflow rule is enabled, workflow engine 510 may consider and utilize the enabled workflow rule during workflow processing. Workflow management facility 520 may dynamically enable or disable a workflow rule in rules table 550 without interrupting runtime operation of workflow engine 510. To illustrate, a new workflow rule may be added to rules table 550 as described above. The new workflow rule may be designed to supersede an existing workflow rule included in rules table 550. Accordingly, a request to disable the existing workflow rule may be provided by a user, and workflow management facility 520 may respond by marking the existing workflow rule as disabled in rules table 550. Consequently, subsequent workflow processing by workflow engine 510 will consider and utilize the new workflow rule and skip over a not utilize the existing disabled workflow rule that has been superseded by the new workflow rule.

The above-described examples of updates to a set of workflow rules included in rules table 550 are illustrative only. Other updates may be dynamically performed to seamlessly update rules table 550 without interrupting runtime operations of workflow engine 510.

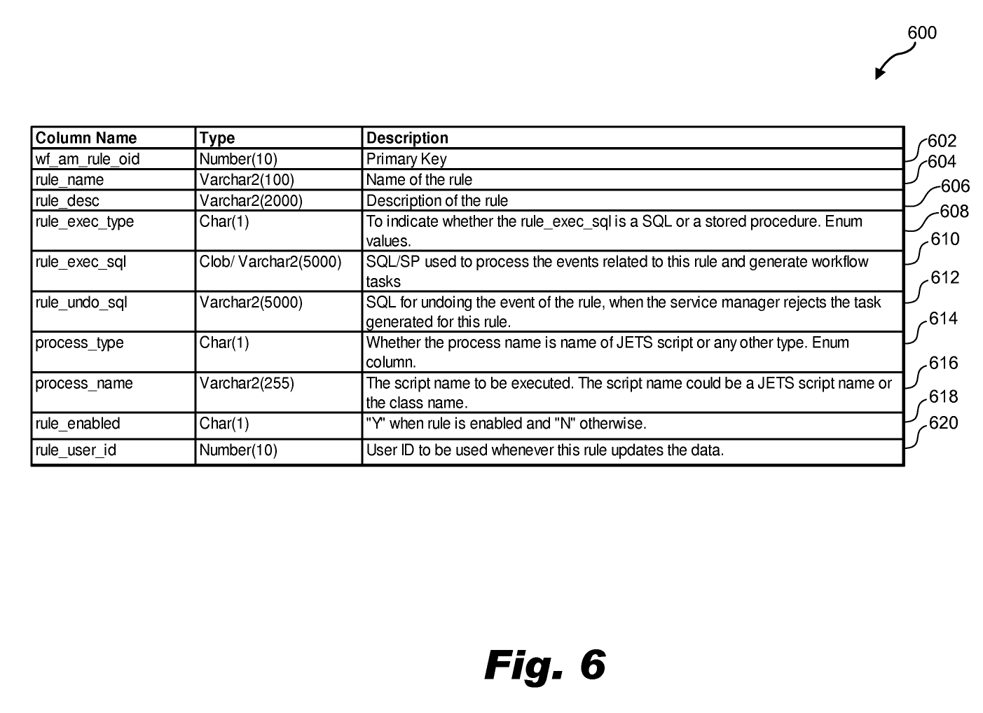

FIG. 6 illustrates an exemplary workflow rule 600 that may be included in rules table 550. As shown in FIG. 6, workflow rule 600 may include fields 602-622. Field 602 may include a “Primary Key” that may be used to index workflow rule 600 in rules table 550. Field 604 may include a workflow rule identifier (e.g., a rule name). Field 606 may include a description of the workflow rule. Field 608 may indicate a type of procedure associated with the workflow rule. Field 610 may include a procedure (e.g., an SQL procedure) that may be executed to process (e.g., screen) events (e.g., discrepancies in the discrepancy table) that qualify for processing in accordance with the workflow rule and to generate workflow tasks for the qualifying events. Field 612 may include a procedure (e.g., an SQL procedure) that may be executed to undo a data update such as when a manager responds to a workflow task with a rejection of the data update. Field 614 may indicate a type of a script associated with the workflow rule. Field 616 may include a reference (e.g., a mapping) to a script in script table 560 that is to be executed in associated with the workflow rule. Field 618 may indicate whether the workflow rule is enabled or disabled for workflow processing. Field 620 may indicate a user identifier that is to be used when the workflow rule is utilized to update data. The exemplary workflow rule 600 shown in FIG. 6 is illustrative only. Other configurations of workflow rules 600 may be employed in other embodiments.

In certain embodiments, system 500 may be configured to support batch processing and/or bulk approval of data integration conflicts. To illustrate, a single business activity such as a merger of Customer A and Customer B may trigger one or more data updates. In association with these updates, data integration subsystem 120 may detect and record multiple discrepancies in a discrepancy table. For example, the discrepancies may include a separate discrepancy record for each subscriber record and/or subscription record affected by the update and for which a discrepancy now exists. System 500 may be configured to group multiple related discrepancies into a batch for batch processing. For instance, system 500 may be able to identify related discrepancies based on screening conditions specified in the workflow rules and to group the related discrepancies into a batch.

Additionally or alternatively, system 500 may be configured to identify and group related workflow tasks for batch processing. In certain examples, this may be accomplished by grouping workflow tasks for discrepancies that have already been identified as being related. In other examples, system 500 may be configured to analyze attributes of workflow tasks and group related workflow tasks together for processing as a batch. For example, a batch of workflow tasks may be routed to a destination such that personnel responding to the workflow tasks may consider and provide input for workflow tasks as a batch. Accordingly, a user may indicate an acceptance, rejection, or other action for a batch of workflow tasks rather than having to provide an individual response for each individual workflow task.

In certain embodiments, workflow interface facility 530 may provide one or more user interface tools configured to facilitate bulk handling of workflow tasks. The tools may include any user interface tools that allow a user to indicate an acceptance, rejection, or other action for a batch of workflow tasks rather than having to provide an individual response for each individual workflow task. In certain examples, workflow interface facility 530 may be configured to group related workflow tasks together for bulk handling by a user.

Data integration conflicts and/or associated workflow tasks may be grouped for batch processing and/or bulk handling based on any suitable attributes of the data integration conflicts and/or associated workflow tasks. For example, groupings may be made based on types of data updates (e.g., mapping versus content updates), shared parent node or root node, customer, account, account type, timestamps, dates, urgency levels, and any other attributes of data updates and/or workflow tasks.

In certain embodiments, system 500 may be configured to perform one or more operations to clean up outstanding workflow tasks and/or data integration conflicts. For example, system 500 may be configured to identify and automatically cancel outdated workflow tasks. For instance, a first workflow task may be generated in relation to a data integration conflict. Subsequently, the data causing the data integration conflict may be changed and a new workflow task generated. The new workflow task may supersede the first workflow task, which is now outdated. System 500 may be configured to detect such an occurrence (e.g., that the first workflow task is outdated because of the new workflow task) and automatically cancel the first workflow task.

Additionally or alternatively, system 500 may be configured to clean up data included in a discrepancy table. For example, system 500 may be configured to identify duplicate records in the discrepancy table. System 500 may response by deleting duplicates from the discrepancy table and/or providing a notification of the duplicates for processing by another entity to clean up the discrepancy table.

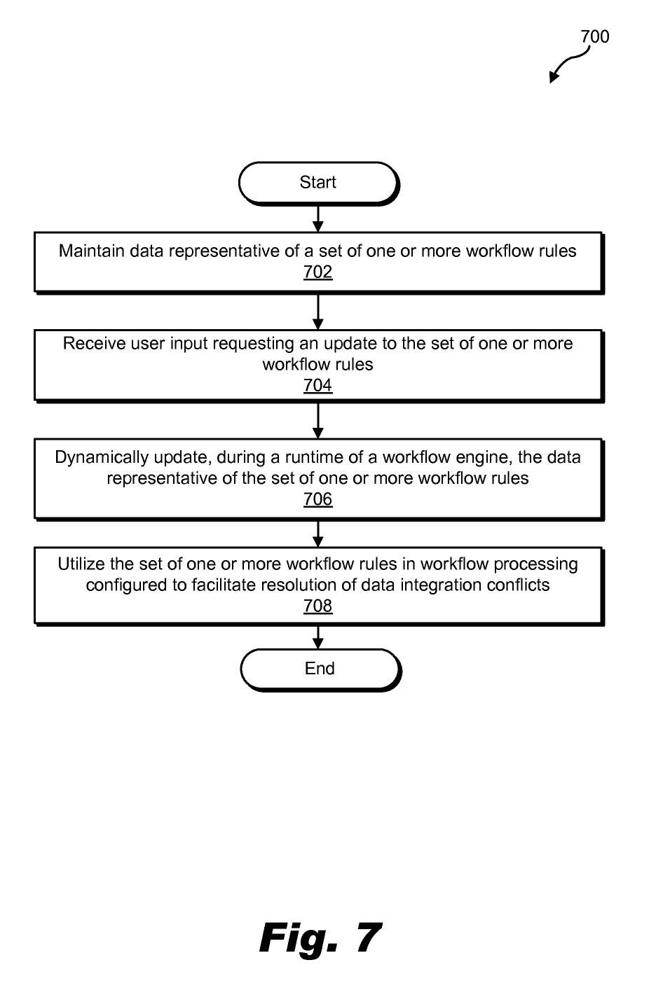

FIG. 7 illustrates an exemplary workflow rules management method. While FIG. 7 illustrates exemplary steps according to one embodiment, other embodiments may omit, add to, reorder, and/or modify any of the steps shown in FIG. 7. In certain embodiments, one or more of the steps shown in FIG. 7 may be performed by one or more components of system 500, data integration subsystem 120, and/or system 100.

In step 702, data representative of a set of one or more workflow rules is maintained. Step 702 may be performed in any of the ways described above. For example, system 500, data integration subsystem 120, and/or system 100 may maintain data representative of the workflow rules in rules table 550 in workflow data store 540.

In step 704, user input requesting an update to the set of one or more workflow rules is received. Step 704 may be performed in any of the ways described above. For example, system 500, data integration subsystem 120, and/or system 100 may receive user input requesting that an update be made to the set of one or more workflow rules. The update may include one or more of the exemplary updates described above.

In step 706, the data representative of the set of one or more workflow rules is dynamically updated during a runtime of a workflow engine (e.g., workflow engine 510) that is configured to utilize the workflow rules in workflow processing, without interrupting runtime operation of the workflow engine, system 500, data integration subsystem 120, and/or system 100. Step 706 may be performed in any of the ways described above.

In step 708, the set of one or more workflow rules is utilized in workflow processing that is configured to facilitate resolution of data integration conflicts detected in association with one or more data integration processes. Step 708 may be performed in any of the ways described above. For example, workflow engine 510 may screen data integration conflicts, generate workflow tasks, and route workflow tasks as described above based on the set of one or more workflow rules.

In the preceding description, various exemplary implementations have been described with reference to the accompanying drawings. It will, however, be evident that various modifications and changes may be made thereto, and additional implementations may be provided, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A method comprising:
maintaining, by a data integration subsystem, data representative of a set of one or more workflow rules configured for use by a workflow engine within the data integration subsystem to
screen one or more data integration conflicts for workflow processing based on the set of one or more workflow rules, and
generate one or more workflow tasks for the screened one or more data integration conflicts based on the set of one or more workflow rules;
receiving, by the data integration subsystem, user input requesting an update to the set of one or more workflow rules; and
dynamically updating, by the data integration subsystem, during a runtime of the workflow engine, the data representative of the set of one or more workflow rules to reflect the update.

2. The method of claim 1, wherein the dynamically updating comprises adding a new workflow rule to the set of one or more workflow rules without interrupting the runtime of the workflow engine.

3. The method of claim 1, wherein the dynamically updating comprises modifying a workflow rule within the set of one or more workflow rules without interrupting the runtime of the workflow engine.

4. The method of claim 1, wherein the dynamically updating comprises one of enabling and disabling a workflow rule within the set of one or more workflow rules without interrupting the runtime of the workflow engine.

5. The method of claim 1, wherein the dynamically updating comprises updating, without interrupting the runtime of the workflow engine, a rules table including the set of one or more workflow rules and a script table including one or more scripts that are mapped to the set of one or more workflow rules by information included in the rules table.

6. The method of claim 1, further comprising:
screening, by the workflow engine within the data integration subsystem, the one or more data integration conflicts for workflow processing based on the set of one or more workflow rules;
generating, by the workflow engine within the data integration subsystem, the one or more workflow tasks for the screened one or more data integration conflicts based on the set of one or more workflow rules, the one or more workflow tasks configured to facilitate resolution of the one or more data integration conflicts; and
routing, by the workflow engine within the data integration subsystem, the one or more workflow tasks to one or more destinations based on the set of one or more workflow rules.

7. The method of claim 1, embodied as computer-executable instructions on at least one tangible computer-readable medium.

8. A method comprising:
receiving, by a data integration subsystem, a first set of one or more local data updates from a plurality of local data subsystems;
detecting, by the data integration subsystem, a first set of one or more data integration conflicts across the plurality of local data subsystems based on the first set of one or more local data updates;
selectively screening, by the data integration subsystem, the first set of one or more data integration conflicts for workflow processing based on a set of one or more workflow rules;
generating, by the data integration subsystem, one or more workflow tasks for one or more selectively screened data integration conflicts within the first set of one or more data integration based on the set of one or more workflow rules;
routing, by the data integration subsystem, the one or more workflow tasks to one or more destinations based on the set of one or more workflow rules;
receiving, by the data integration subsystem, one or more responses to the one or more workflow tasks; and
facilitating, by the data integration subsystem, a resolution of the one or more selectively screened data integration conflicts based on the one or more responses to the one or more workflow tasks.

9. The method of claim 8, further comprising:
maintaining, by the data integration subsystem, data representative of the set of one or more workflow rules;
receiving, by the data integration subsystem, user input requesting an update to the set of one or more workflow rules; and
dynamically updating, by the data integration subsystem, during a runtime of the data integration subsystem, the data representative of the set of one or more workflow rules to reflect the update.

10. The method of claim 9, further comprising:
receiving, by the data integration subsystem, a second set of one or more local data updates from the plurality of local data subsystems;
detecting, by the data integration subsystem, a second set of one or more data integration conflicts across the plurality of local data subsystems based on the second set of one or more local data updates;
selectively screening, by the data integration subsystem, the second set of one or more data integration conflicts for workflow processing based on the updated set of one or more workflow rules;
generating, by the data integration subsystem, one or more other workflow tasks for one or more selectively screened data integration conflicts within the second set of one or more data integration conflicts based on the updated set of one or more workflow rules;
routing, by the data integration subsystem, the one or more other workflow tasks to one or more destinations based on the updated set of one or more workflow rules;
receiving, by the data integration subsystem, results for the one or more other workflow tasks; and
facilitating, by the data integration subsystem, a resolution of the one or more selectively screened data integration conflicts based on the one or more responses to the one or more workflow tasks.

11. The method of claim 10, further comprising:
determining, by the data integration subsystem, that a workflow task within the one or more other workflow tasks supersedes a workflow task within the one or more workflow tasks; and
automatically canceling, by the data integration subsystem, the superseded workflow task within the one or more workflow tasks in response to the determination.

12. The method of claim 8, further comprising grouping the one or more workflow tasks for batch processing based on one or more attributes of the one or more local data updates in the first set of one or more local data updates.

13. The method of claim 8, embodied as computer-executable instructions on at least one tangible computer-readable medium.

14. A system comprising:
a workflow engine configured to
selectively screen a data integration conflict detected during a data integration process for workflow processing based on a set of one or more workflow rules, and
generate one or more workflow tasks for the selectively screened data integration conflict based on the set of one or more workflow rules;
a workflow interface facility that receives user input requesting an update to the set of one or more workflow rules; and
a workflow management facility that
maintains data representative of the set of one or more workflow rules, and
dynamically updates, during a runtime of the workflow engine and in response to the user input requesting the update, the data representative of the set of one or more workflow rules to reflect the update.

15. The system of claim 14, wherein the workflow management facility dynamically updates the data representative of the set of one or more workflow rules by at least one of
adding a new workflow rule to the set of one or more workflow rules without interrupting the runtime of the workflow engine,
modifying a workflow rule within the set of one or more workflow rules without interrupting the runtime of the workflow engine, and
enabling or disabling a workflow rule within the set of one or more workflow rules without interrupting the runtime of the workflow engine.

16. The system of claim 14, wherein:
the workflow management facility maintains the data representative of the set of one or more workflow rules in a rules table; and
each workflow rule in the set of one or more workflow rules includes a data field indicating whether the workflow rule is enabled or disabled for use in workflow processing.

17. The system of claim 14, wherein the workflow engine:
screens the data integration conflict for workflow processing based on the set of one or more workflow rules,
generates the one or more workflow tasks for the screened data integration conflict based on the set of one or more workflow rules, the one or more workflow tasks configured to facilitate a resolution of the data integration conflict, and
routes the one or more workflow tasks to one or more destinations based on the set of one or more workflow rules.

18. A system comprising:
a data integration subsystem configured to
maintain integrated global data that is mapped to local data maintained by a plurality of local data subsystems,
receive data representative of local data updates from the plurality of local data subsystems,
apply the local data updates to the integrated global data, and
detect a data integration conflict in association with the application of the local data updates to the integrated global data;
a workflow engine configured to
selectively screen the data integration conflict for workflow processing based on a workflow rule within a set of one or more workflow rules, and
generate one or more workflow tasks for the selectively screened data integration conflict based on the workflow rule;
a workflow interface facility configured to receive user input requesting an update to the set of one or more workflow rules; and
a workflow management facility configured to
maintain data representative of the set of one or more workflow rules, and
dynamically update, during a runtime of the workflow engine and in response to the user input requesting the update, the data representative of the set of one or more workflow rules to reflect the update.

19. The system of claim 18, wherein the update comprises at least one of:
an addition of a new workflow rule to the set of one or more workflow rules without interruption of the runtime of the workflow engine;
a modification of the workflow rule within the set of one or more workflow rules without interruption to the runtime of the workflow engine; and
an enabling or disabling of the workflow rule within the set of one or more workflow rules without interruption to the runtime of the workflow engine.

20. The system of claim 18, wherein the local data and the integrated global data comprise customer data records and customer account data records associated with a customer.

21. The system of claim 18, further comprising a portal subsystem communicatively coupled to the data integration subsystem and configured to provide the customer with access to the customer data records and the customer account data records included in the integrated global data maintained by the data integration subsystem.
